(19) United States
(12) Patent Application Publication
(10) Pub. No.: US 2013/0283334 A1
(43) Pub. Date: Oct. 24, 2013

(54) Cable Modem for Supporting Multimedia Over Coax Alliance and Data Over Cable Service Interface Specification Standards

(71) Applicant: Unihan Corporation, Taipei City (TW)

(72) Inventors: Wei-Chun Tsao, Taipei City (TW); Chien-Ru Lin, Taipei City (TW)

(21) Appl. No.: 13/917,792

(22) Filed: Jun. 14, 2013

Related U.S. Application Data
(63) Continuation-in-part of application No. 12/536,563, filed on Aug. 6, 2009.

(30) Foreign Application Priority Data
Aug. 12, 2008 (TW) 097130657

(51) Int. Cl. H04N 21/61

(52) U.S. Cl. CPC H04N 21/6118
USPC 725/149

(57) ABSTRACT

A cable modem is used for supporting a multimedia over coax alliance (MoCA) standard and a data over cable service interface specification (Docsis) standard. The cable modem includes a first terminal coupled to the coaxial cable, a second terminal, a downstream processing circuit for the Docsis standard coupled to the second terminal, and a band pass filter coupled between the first terminal and the second terminal. The band pass filter receives a downstream signal with a plurality of television channel signals and a MoCA standard system signal from the coaxial cable via the first terminal, passes through and transmits the television channel signals of the downstream signal to the downstream processing circuit to be processed, and rejects a MoCA standard system signal of the downstream signal to prevent it from entering the downstream processing circuit.

### CROSS-REFERENCES TO RELATED APPLICATIONS

This non-provisional application claims priority under 35 U.S.C. § 119(a) on patent application Ser. No. 12/536,563 filed in United States on Aug. 6, 2009, the entire contents of which are hereby incorporated by reference.

### BACKGROUND OF THE INVENTION

1. Field of the Invention

The invention relates to an electronic device and, more particularly, to a cable modem for supporting a multimedia over coax alliance (MoCA) standard and a data over cable service interface specification (Docsis) standard.

2. Description of the Related Art

The Ethernet cabling has been the dominant wiring solution in digital homes. The Ethernet cabling may be used to transfer audio, video, and digital data among different rooms at homes, and it may even connect all facilities from whole-house audio systems to home automation and security systems. However, since installation of the Ethernet cabling in a constructed building requires opening up walls, Ethernet is not an ideal choice.

Therefore, engineers at some of the world's leading technology companies are backing two new ways to build a digital home infrastructure. They mainly use wiring existed in every home to put forward the solution. For example, electrical wiring or coaxial cables existed in both a new building and an old building are utilized.

According to the difference of the selected transmitting media, the new digital home connection technique mainly includes two techniques, a HomePlug AV and a multimedia over coax alliance (MoCA). The two techniques are established and popularized by two different technique organizations, a homeplug powerline alliance and a multimedia over coax alliance, respectively.

The MoCA standard can provide stable high-transmission and high-quality network connections for households having various kinds of video equipment via coaxial cables, which does not affect other adopted equipment or networks. The MoCA standard mainly has the following advantages. First, a data transmission rate can greatly increase without changing arrangements and layout of the existing cable television networks. Second, the highest transmission rate in each 50 MHz channel may reach 270 Mbps, and a whole transmission rate of 15 channels may reach four Gbps. Third, original video signals are not affected, and the cable television network may exist at the same time. Fourth, quality of service is perfect, safety and reliability is high, and installation is convenient.

FIG. 1 is a schematic diagram of a conventional electronic device for supporting a MoCA standard. As shown in FIG. 1, the electronic device 1 includes an input terminal 11, a high pass filter 12, and a tuner 13. Generally speaking, a MoCA system has a high-frequency operating signal which is a MoCA high-power signal higher than 50 dBmV. However, the MoCA high-power signal may be transmitted to the input terminal 11 via coaxial cables, which seriously affects operations of the tuner 13 or an amplifier. Thus, reception of the digital television signals is affected.

FIG. 1A is a schematic diagram of another conventional electronic device for supporting a MoCA standard. As shown in FIG. 1A, a circuit board 4 has a first low-pass wave-filtering circuit 41, and a band-pass wave-filtering circuit 42. The band-pass wave-filtering circuit 42 consists of a high-pass wave-filtering circuit 421 and a second low-pass wave-filtering circuit 422. The first low-pass wave-filtering circuit 41 is connected to the high-pass wave-filtering circuit 421. The circuit board 4 further includes an input terminal 43, and a first switching component 46, which is movable to such a position as to electrically connect the input terminal 43 and a joint between the first low-pass wave-filtering circuit 41 and the high-pass wave-filtering circuit 421. The circuit board further includes two output terminals 44, 45, which are connected to the first and the second low-pass wave-filtering circuits 41, 422, respectively. A second switching component 47 is provided on the circuit board 4, which is movable to such a position as to electrically connect the high-pass wave-filtering circuit 421 and the second low-pass wave-filtering circuit 422. However, the circuit board 4 is just applied for the downstream signals, and the filtering functions are chose by the switching components 46 and 47. For using the switching component 46 and 47, the circuit board 4 need to be independently disposed, i.e. disposed in outside of the cable modem.

### BRIEF SUMMARY OF THE INVENTION

One objective of the invention is to provide a cable modem for supporting a multimedia over coax alliance (MoCA) standard and a data over cable service interface specification (Docsis) standard to improve the conventional technology.

A cable modem is used for supporting a MoCA standard and a Docsis standard, and includes a first terminal coupled to the coaxial cable, a second terminal, a downstream processing circuit for the Docsis standard coupled to the second terminal, and a band pass filter coupled between the first terminal and the second terminal The band pass filter receives a downstream signal with a plurality of television channel signals and a MoCA standard system signal from the coaxial cable via the first terminal, passes through and transmits the television channel signals of the downstream signal to the downstream processing circuit to be processed, and rejects a MoCA standard system signal of the downstream signal to prevent it from entering the downstream processing circuit.

In some embodiments, the cable modem further includes a third terminal, a MoCA circuit for the MoCA standard coupled to the third terminal, and a high pass filter coupled between the first terminal and the third terminal. The high pass filter receives the downstream signal from the coaxial cable via the first terminal, passes through and transmits the MoCA standard system signal of the downstream signal to the downstream processing circuit to be processed, and rejects the television channel signals of the downstream signal.

In some embodiments, the cable modem further includes a fourth terminal, a upstream processing circuit for the Docsis standard coupled to the fourth terminal, and a low pass filter coupled between the first terminal and the fourth terminal The low pass filter outputs an upstream signal from the coaxial cable via the first terminal

In some embodiments, the upstream signal and the downstream signal simultaneously exist in the coaxial cable.

In some embodiments, the second terminal, the downstream processing circuit, the band pass filter, the third terminal, the MoCA circuit, the high pass filter, the fourth terminal, the upstream processing circuit and the low pass filter are disposed inside a television (TV) or a set-top box (STB).

In some embodiments, the second terminal, the downstream processing circuit, the band pass filter, the third terminal, the MoCA circuit, the high pass filter, the fourth terminal, the upstream processing circuit and the low pass filter are formed in a main PCB (Printed Circuit Board) of the TV or the STB.

In some embodiments, the width of the predetermined frequency range of the television channel signals is at least 917 MHz, and the frequency of the MoCA standard system signal is between 1125 MHz and 1500 MHz.

In some embodiments, the predetermined frequency range is from 54 MHz to 1002 MHz or from 85 MHz to 1002 MHz.

In some embodiments, the number of the television channel signals is thirteen.

In some embodiments, the downstream processing circuit is a tuner or an amplifier.

In some embodiments, the downstream processing circuit is the tuner including a band pass filter. The band pass filter selects one of the television channel signals, so that the tuner processes the selected television channel signal.

One beneficial effect of the invention is that the electronic device in the invention can allow the television channel signals in the predetermined frequency range to pass through and reject high-power MoCA standard system signals between 1125 MHz and 1500 MHz to pass through. Thereby, viewing quality of the television channel signals can be improved.

These and other features, aspects, and advantages of the present invention will become better understood with regard to the following description, appended claims, and accompanying drawings.

### BRIEF DESCRIPTION OF THE DRAWINGS

FIG. 1 is a functional block diagram of a conventional electronic device for supporting a multimedia over coax alliance (MoCA) standard.

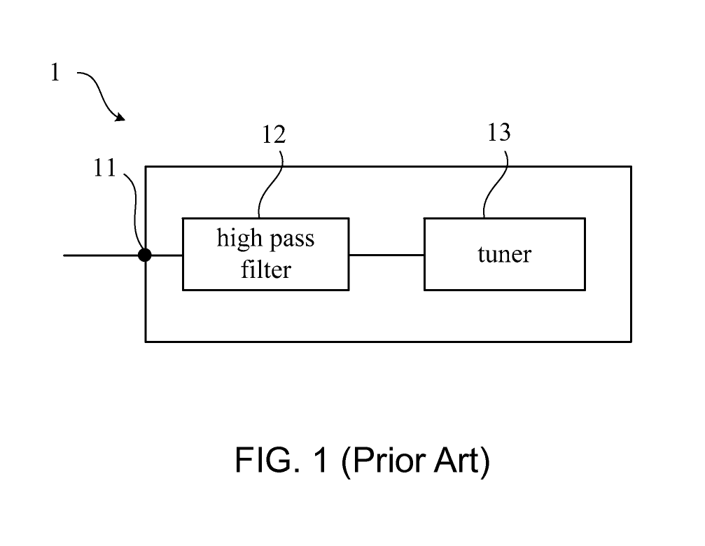

FIG. 1A is a schematic diagram of another conventional electronic device for supporting a MoCA standard.

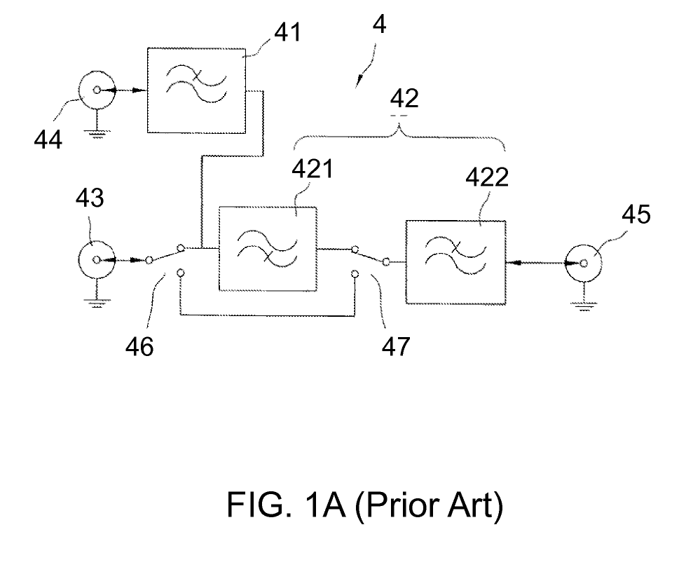

FIG. 2 is a functional block diagram of an electronic device for supporting a MoCA standard according to an embodiment of the invention.

FIG. 2A is a functional block diagram of a cable modem for supporting MoCA and Docsis standards according to an embodiment of the invention.

FIG. 3 is a functional block diagram of an electronic device for supporting a MoCA standard according to another embodiment of the invention.

### DETAILED DESCRIPTION OF THE EMBODIMENTS

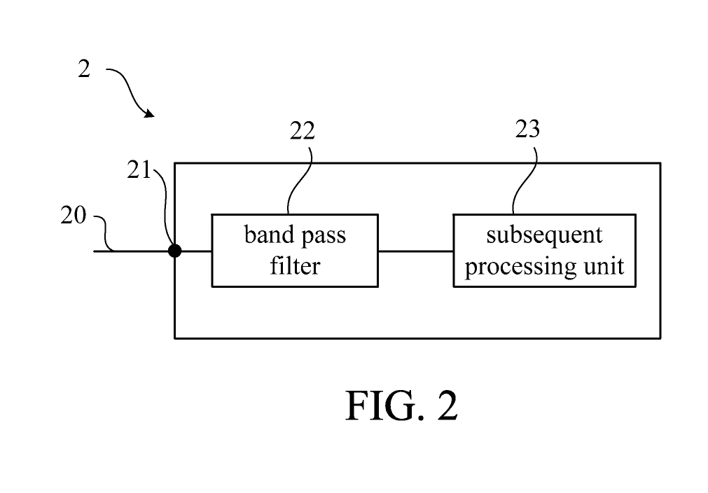

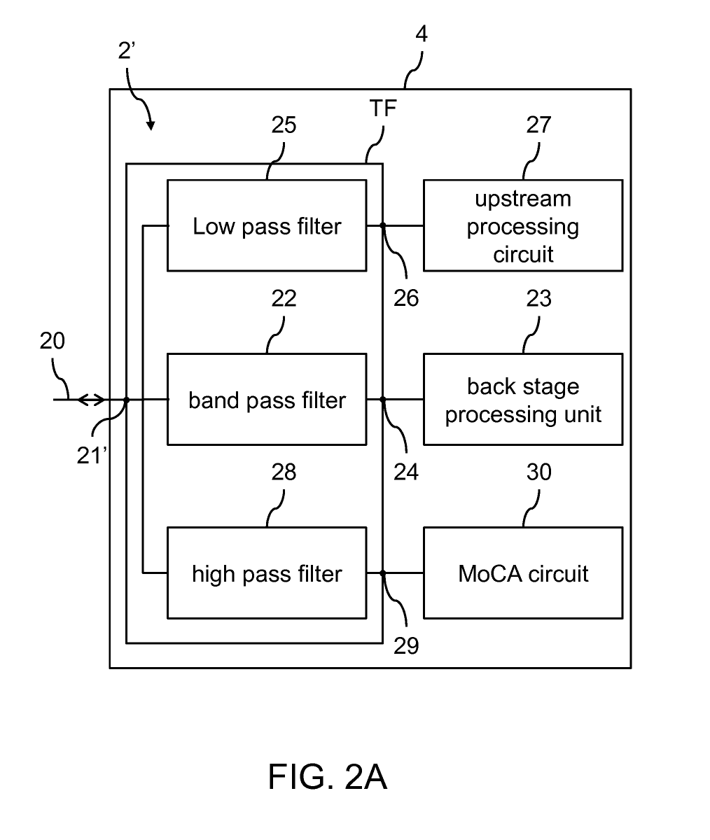

FIG. 2 is a functional block diagram of an electronic device for supporting a MoCA standard according to an embodiment of the invention. In the embodiment, an electronic device 2 may be a digital television set-top box or a cable modem. The electronic device 2 can be coupled with a coaxial cable 20 to receive multimedia information sent from a remote system via the coaxial cable 20. The multimedia information may include digital television signals, audio signals, network data, and so on.

As shown in FIG. 2, the electronic device 2 in the embodiment includes an input terminal 21, a band pass filter 22, and a back stage processing unit 23. The input terminal 21 is coupled with the coaxial cable 20, and the band pass filter 22 is coupled between the input terminal 21 and the back stage processing unit 23. The back stage processing unit 23 is a back stage of the band pass filter 22.

In the embodiment, the input terminal 21 is a coaxial cable connector for connecting the coaxial cable 20. In the embodiment, the back stage processing unit 23 is an amplifier. In other embodiments, the back stage processing unit 23 may be a tuner or another electronic device which is used to receive cable television signals or digital television signals.

In the embodiment, the band pass filter 22 is used to allow signals in a predetermined frequency range to pass through the band pass filter 22. The width of the predetermined frequency range is at least 917 MHz. For example, the predetermined frequency range is from 85 MHz to 1002 MHz. In other embodiments, the predetermined frequency range may be from 54 MHz to 1002 MHz, and the predetermined frequency range can be modified by adjusting the frequency range of the band pass filter 22 according to requirements of the cable system.

The band pass filter 22 receives an input signal from the input terminal 21, and the input signal includes a plurality of television channel signals and a multimedia over coax alliance (MoCA) standard system signal. In the embodiment, the power of the MoCA standard system signal is 50 dBmV, and the frequency of the MoCA standard system signal is between 1125 MHz and 1500 MHz. The power of every television channel signal is 15 dBmV, and the frequency of the television signal of every channel distributes between 54 MHz and 860 MHz. The number of the television channel signals is thirteen.

In the embodiment, the band pass filter 22 has a characteristic, that is, wide bandwidth signals can pass through the band pass filter 22. Therefore, a plurality of television channel signals in the predetermined frequency range may pass through the band pass filter 22 to enter the back stage processing unit 23, and the signals out of the predetermined frequency range, such as high-power MoCA standard system signals between 1125 MHz and 1500 MHz, will be reject. Thereby, the back stage processing unit 23 such as an amplifier does not receive the high-power MoCA standard system signals and then does not distort signals.

For example, an amplifier amplifies the 15 dBmV television channel signals. If the amplifier receives 50 dBmV high-power MoCA standard system signals and amplifies them, the television channel signals may be distorted. Thus, a back stage processing of the electronic device 2 is affected. In the embodiment, the band pass filter 22 can solve the above problem. The back stage processing unit 23 such as an amplifier can operate normally.

In other Words, referring to FIG. 2A, it is assumed that the electronic device 2 is the cable modem 2′. The cable modem 2′ is disposed inside a television (TV) or a set-top box (STB). That is, the cable modem 2′ is formed in the main PCB of the TV or the STB.

The cable modem 2′ includes a triplexes filter TF a plurality of transmission terminal 21′, 24, 26, 29. For convenience of description, the transmission terminal 21′, 24, 26, 29 are referred to a first terminal 21′, a second terminal 24, third terminal 26 and a fourth terminal 29, respectively. Herein, the terms “first”, “second”, “third” and “fourth” are used to differentiate the signified elements, are not intended to sort or restrict the signified elements to indicate the difference, and also not intended to limit the scope of the present invention.

The triplexes filter TF is formed in the main PCB (Printed Circuit Board) 4 of the TV or the STB.

The first terminal 21′ (i.e. above input terminal 21) of the triplexes filter TF is connected to the coaxial cable 20, and two-way signal is transmitted between the triplexes filter TF and the coaxial cable 20.

The second terminal 24 of the triplexes filter TF is connected to back stage processing unit 23 of the TV or the STB. In some embodiments, the back stage processing unit 23 is a Docsis (Data Over Cable Service Interface Specification) downstream processing circuit, such as a Low-noise amplifier or a tuner.

The third terminal 26 of the triplexes filter TF is connected to upstream processing circuit 27 of the TV or the STB. In some embodiments, the upstream processing circuit 27 is a Docsis upstream processing circuit.

The fourth terminal 29 of the triplexes filter TF is connected to MoCA circuit 30 of the TV or the STB.

The triplexes filter TF includes three filters, i.e. the band pass filter 22, a low pass filter 25 and a high pass filter 28.

The two terminal of the band pass filter 22 are coupled to the first terminal 21′ and the second terminal 24, respectively. That is, the band pass filter 22 is coupled between the coaxial cable 20 and the back stage processing unit 23.

The low pass filter 25 is coupled to first terminal 21′ are coupled to the first terminal 21′ and the third terminal 26, respectively. That is, the low pass filter 25 is coupled between the coaxial cable 20 and the upstream processing circuit 27.

The high pass filter 28 is coupled to first terminal 21′ are coupled to the first terminal 21′ and the fourth terminal 29, respectively. That is, the low pass filter 25 is coupled between the coaxial cable 20 and the MoCA circuit 30.

The low pass filter 25 outputs the upstream signal for Docsis standard into the coaxial cable 20.

The band pass filter 22 and the high pass filter 28 receive the downstream signal for Docsis standard and MoCA standard.

That is, the two-way signal in the coaxial cable 20 includes the upstream signal for Docsis standard and the downstream signal for Docsis standard and MoCA standard, and the upstream signal and the downstream signal can be simultaneously transmitted in the coaxial cable 20. Moreover, the downstream signal include the Docsis signals, i.e. the digital television channel signals (also known as cable television (CATV) signals), and the MoCA signal, i.e. MoCA standard system signal.

When the band pass filter 22 receives the downstream signal, the band pass filter 22 rejects (filters out) the MoCA signal of the downstream signal and passes through the Docsis signals of the downstream signal, thereby preventing the MoCA signal from entering the back stage processing unit 23. That is the band pass filter 22 just outputs the Docsis signals of the downstream signal into the back stage processing unit 23.

When the low pass filter 25 receives the downstream signal, the band pass filter 22 filters out/rejects the Docsis signal of the downstream signal and passes through the MoCA signals of the downstream signal. That is the band pass filter 22 just outputs the MoCA signals of the downstream signal into the MoCA circuit 30, thereby preventing the Docsis signal from entering the MoCA circuit 30.

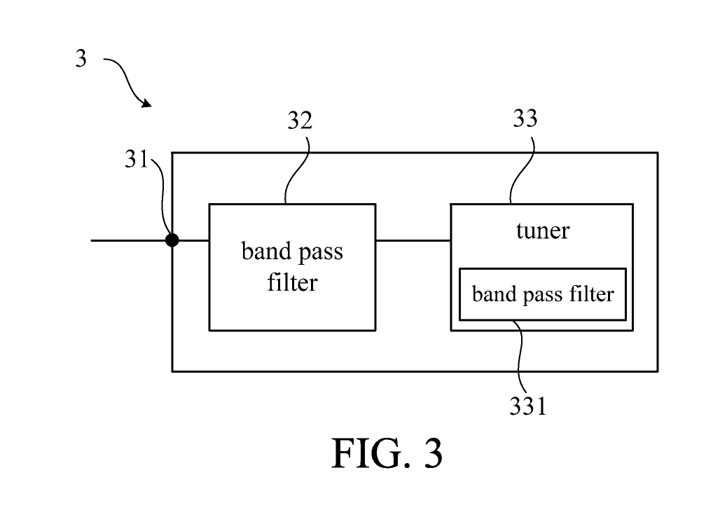

FIG. 3 is a functional block diagram of an electronic device for supporting a MoCA standard according to another embodiment of the invention. An electronic device 3 in the embodiment includes an input terminal 31, a band pass filter 32, and a tuner 33. The elements of the embodiment are similar with the elements of the above embodiment. Therefore, the connection relationship and fundamental functions of the elements are not described repeatedly.

In the embodiment, the tuner 33 is a back stage processing unit of the band pass filter 32. The tuner 33 further includes a band pass filter 331. The band pass filter 32 allows a plurality of television channel signals to pass through and transmits them to the tuner 33. The band pass filter 331 in the tuner 33 can be used to select one of the digital television channel signals. Thereby, the tuner 33 processes the selected digital television channel signal.

To sum up, the electronic device in the embodiment of the invention can allow a plurality of digital television channel signals in the predetermined frequency range to pass through and reject a MoCA standard system signal to pass through at the same time, which may prevent the MoCA standard system signal from interfering with the digital television channel signals. Thus, transmitting quality of the television channel signals on a cable increases.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A cable modem for supporting a multimedia over coax alliance (MoCA) standard and a data over cable service interface specification (Docsis) standard, coupled with a coaxial cable, the cable modem comprising:
a first terminal, coupled to the coaxial cable;
a second terminal;
a downstream processing circuit for the Docsis standard, coupled to the second terminal; and
a band pass filter, coupled between the first terminal and the second terminal, for receiving a downstream signal including a plurality of television channel signals and a MoCA standard system signal from the coaxial cable via the first terminal, passing through and transmitting the television channel signals of the downstream signal to the downstream processing circuit to be processed, and rejecting the MoCA standard system signal of the downstream signal to prevent it from entering the downstream processing circuit.

2. The cable modem according to claim 1, further comprising:
a third terminal;
a MoCA circuit for the MoCA standard, coupled to the third terminal; and
a high pass filter, coupled between the first terminal and the third terminal, for receiving the downstream signal from the coaxial cable via the first terminal, passing through and transmitting the MoCA standard system signal of the downstream signal to the MoCA circuit to be processed, and rejecting the television channel signals of the downstream signal.

3. The cable modem according to claim 2, further comprising:
a fourth terminal;
a upstream processing circuit for the Docsis standard, coupled to the fourth terminal; and
a low pass filter, coupled between the first terminal and the fourth terminal, for outputting an upstream signal from the coaxial cable via the first terminal.

4. The cable modem according to claim 3, wherein the upstream signal and the downstream signal simultaneously exist in the coaxial cable.

5. The cable modem according to claim 3, wherein the second terminal, the downstream processing circuit, the band pass filter, the third terminal, the MoCA circuit, the high pass filter, the fourth terminal, the upstream processing circuit and the low pass filter are disposed inside a television (TV) or a set-top box (STB).

6. The cable modem according to claim 5, wherein the second terminal, the downstream processing circuit, the band pass filter, the third terminal, the MoCA circuit, the high pass filter, the fourth terminal, the upstream processing circuit and the low pass filter are formed in a main PCB (Printed Circuit Board) of the TV or the STB.

7. The cable modem according to claim 1, further comprising:
a third terminal;
a upstream processing circuit for the Docsis standard, coupled to the third terminal; and
a low pass filter, coupled between the first terminal and the third terminal, for outputting an upstream signal from the coaxial cable via the first terminal.

8. The cable modem according to claim 7, wherein the upstream signal and the downstream signal simultaneously exist in the coaxial cable.

9. The cable modem according to claim 7, wherein the second terminal, the downstream processing circuit, the band pass filter, the third terminal, the upstream processing circuit and the low pass filter are disposed inside a TV or a STB.

10. The cable modem according to claim 9, wherein the second terminal, the downstream processing circuit, the band pass filter, the third terminal, the upstream processing circuit and the low pass filter are formed in a main PCB of the TV or the STB.

11. The cable modem according to claim 1, wherein a width of a predetermined frequency range of the television channel signals is at least 917 MHz, and the frequency of the MoCA standard system signal is between 1125 MHz and 1500 MHz.

12. The cable modem according to claim 11, wherein the predetermined frequency range is from 54 MHz to 1002 MHz or from 85 MHz to 1002 MHz.

13. The cable modem according to claim 1, wherein the number of the television channel signals is thirteen.

14. The cable modem according to claim 1, wherein the downstream processing circuit is a tuner or an amplifier.

15. The cable modem according to claim 14, wherein the downstream processing circuit is the tuner comprising a band pass filter for selecting one of the television channel signals, so that the tuner processes the selected television channel signal.
